(19) United States
(12) Patent Application Publication
(10) Pub. No.: US 2025/0373597 A1
(43) Pub. Date: Dec. 4, 2025

(54) SYSTEMS AND METHODS FOR PROVIDING SECURE ACCESS TO VEHICLE SYSTEMS

(71) Applicant: NIO TECHNOLOGY (ANHUI) CO., LTD., Anhui (CN)

(72) Inventors: Hao CAI, Sammamish, WA (US); Haiyong XIE, Pleasanton, CA (US); Yanyan SHEN, San Jose, CA (US); Ge SHEN, San Jose, CA (US)

(21) Appl. No.: 18/678,730

(22) Filed: May 30, 2024

(51) Int. Cl. H04L 9/40

(52) U.S. Cl. CPC H04L 63/0823; H04L 63/0428

(57) ABSTRACT

In some embodiments, apparatuses and methods are provided herein useful to allowing a connection to a vehicle. In some implementations, a method comprises receiving, by an authorization server from a remote device, a connection request for the vehicle, verifying, by the authorization server, the connection request, in response to verifying the connection request, generating by the authorization server, an authorization certificate, transmitting, by the authorization server, the authorization certificate, receiving, by the vehicle, the authorization certificate, authenticating, by the vehicle, the authorization certificate, and in response to the authenticating the authorization certificate, activating, by the vehicle, a vehicle communication system.

### TECHNICAL FIELD

This invention relates generally to vehicles and, more specifically, providing secure access with authenticated, and authorized, operations to vehicles.

### BACKGROUND

Typically, vehicles (e.g., passenger and commercial automobiles) include mechanisms for accessing information associated with the vehicles. For example, most vehicles include an onboard diagnostic (OBD) port. Traditionally, the information that can be accessed has been primarily diagnostic information associated with the vehicle. The diagnostic information associated with the vehicle can be accessed via the OBD port. For example, a person can physically connect a device (e.g., a diagnostic tool) to the OBD port to access the diagnostic information. While such an OBD port allows diagnostic information associated with a vehicle to be accessed, it offers little in the way of security. For example, OBD port security, traditionally, was based on the fact that one would need physical access to the OBD port to access the diagnostic information. Because the OBD port is located inside the vehicle, unauthorized access was prevented simply by preventing access to the vehicle (e.g., by locking the vehicle's doors).

Vehicles, however, are becoming significantly more advanced. While the information to be accessed via an OBD port was once primarily limited to diagnostic information, modern vehicles may have many systems that are accessible via the OBD port. Accordingly, unauthorized access to the OBD port can cause much greater harm than the receipt of diagnostic information. For example, in a modern vehicle, engine control parameters, self-driving controls, and connected device information can be accessed and/or modified via the OBD port. To further complicate matters, many modern vehicles are capable of being accessed wirelessly (“over-the-air” or “OTA”). This wireless access can be performed either via a device that is communicatively coupled the OBD port (e.g., a “dongle” device) or a wireless radio associated with the vehicle. When connecting to a vehicle wirelessly, physical access is not required and simply preventing access to the interior of the vehicle will not provide the required security. Accordingly, a need exists for improved systems and methods for secure access to the vehicle's onboard systems.

### SUMMARY

In some implementations, a method for allowing a connection to a vehicle comprises receiving, by an authorization server from a remote device, a connection request for the vehicle, verifying, by the authorization server, the connection request, in response to verifying the connection request, generating by the authorization server, an authorization certificate, transmitting, by the authorization server, the authorization certificate, receiving, by the vehicle, the authorization certificate, authenticating, by the vehicle, the authorization certificate, and in response to the authenticating the authorization certificate, activating, by the vehicle, a vehicle communication system.

In some embodiments, a system for allowing a connection to a vehicle comprises an authorization server, wherein the authorization server is configured to receive, from a remote device, a connection request for the vehicle, verify the connection request, in response to verifying the connection request, generate an authorization certificate, and transmit the authorization certificate, and the vehicle, wherein the vehicle is configured to authenticate the authorization certificate and in response to authenticating the authorization certificate, activate the vehicle communication system.

### BRIEF DESCRIPTION OF THE DRAWINGS

Disclosed herein are embodiments of systems, apparatuses, and methods pertaining allowing a connection to a vehicle. This description includes drawings, wherein:

FIG. 1 is a block diagram of a system including example operations for allowing a connection to a vehicle, according to some implementations;

FIG. 2 is a block diagram of a system for allowing a connection to a vehicle, according to some implementations;

FIG. 3 is a block diagram of a sample implementation of a system for allowing connection to a vehicle including additional detail with respect to FIG. 2, according to some implementations;

FIG. 4 is a flow chart depicting example operations for allowing a connection to a vehicle, according to some implementations;

FIG. 5 is a flow chart depicting example operations in addition to those of FIG. 4 in which an owner prompt is transmitted to an owner of a vehicle, according to some implementations;

FIG. 6 is a flow chart depicting example operations in addition to those of FIG. 4 for deactivating a communication system of a vehicle, according to some implementations; and

FIG. 7 is a block diagram of a system that may be used for implementing any of components, circuits, circuitry, systems, functionality, apparatuses, processes, or devices of the system of FIG. 2 and/or 3, and/or other above or below mentioned systems or devices, or parts of such circuits, circuitry, functionality, systems, apparatuses, processes, or devices, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various implementations, systems, apparatuses, and methods are provided herein useful to allowing a connection to a vehicle. In some implementations, a method comprises receiving, by an authorization server from a remote device, a connection request for the vehicle, verifying, by the authorization server, the connection request, in response to verifying the connection request, generating by the authorization server, an authorization certificate, transmitting, by the authorization server, the authorization certificate, receiving, by the vehicle, the authorization certificate, authenticating, by the vehicle, the authorization certificate, and in response to the authenticating the authorization certificate, activating, by the vehicle, a vehicle communication system.

As previously discussed, vehicles (e.g., passenger and commercial automobiles) typically include a mechanism for accessing information associated with the vehicle. Traditionally, this mechanism has been a physical port located inside the vehicle (e.g., an OBD port). Additionally, the information accessible via the OBD port was typically diagnostic information associated with the vehicle. For example, plugging a diagnostic tool into a vehicle may reveal code P0401, indicating a problem with the vehicle's exhaust gas recirculation (EGR) system. Because the information that was accessible via the OBD port was limited to diagnostic information, there was little potential for a malicious actor to cause harm to the vehicle if the diagnostic information was accessed in an unapproved manner. Accordingly, because of the low risk, OBD port security was minimal. Typically, OBD port security was limited to preventing physical access to the interior of the vehicle, and thus the OBD port.

In modern vehicles, the information that is accessible via the OBD port has expanded as vehicles have become more complex and connected. For example, a modern vehicle may store information and/or parameters associated with self-driving features, personal information of the user, engine control parameters, etc. Accordingly, in a modern vehicle, if a malicious actor has access to one or more of the vehicle's electronic control units (ECUs), the malicious actor could hinder a vehicle's self-driving functionality, access the user's personal information, etc.

While vehicles have advanced at an incredible rate, security associated with access to information associated with the vehicle has remained largely stagnant. Further complicating matters is that many modern vehicles include wireless (e.g., “over-the-air,” or “OTA”) connections. Such wireless access can be performed either via a device that is communicatively coupled to the OBD port (e.g., a “dongle” device) or a wireless radio associated with the vehicle. With a wireless connection, the traditional physical access prevention of the OBD port (e.g., by locking a vehicle's doors) is ineffective.

Today, most security mechanisms, if any are employed, to prevent unauthorized access to a vehicle via a communications channel operate at the application layer. That is, a connection is not authenticated until after the connection has been made and data has been exchanged between the device connected to the vehicle (e.g., a “remote device”) and the vehicle. Because such security mechanisms authenticate after a connection has been made, a potentially unauthorized device is already communicating with the vehicle and the security mechanisms may be defeated. Further, even if the security mechanism is successful in preventing unauthorized access to sensitive information or controls, because a connection has already been established, attacks can occur that disable and/or alter the operation of the vehicle (e.g., via a denial of service “DOS” attack).

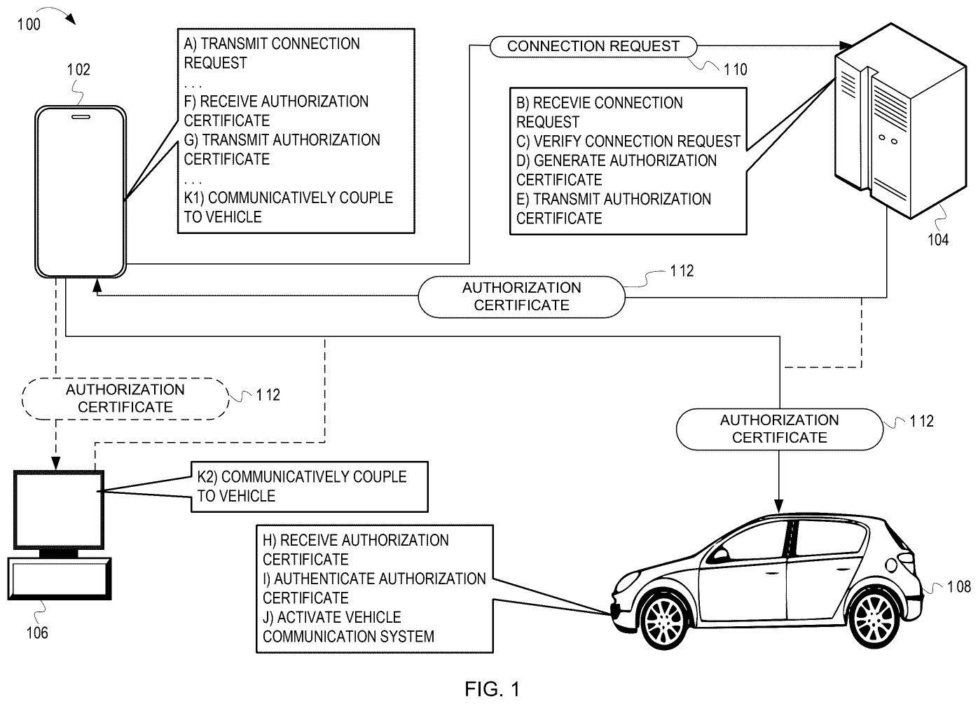

Described herein are systems, methods, and apparatuses that seek to minimize, if not eliminate, the drawbacks of current security mechanisms. In one implementation, authentication is performed remotely from the vehicle. For example, a remote device (i.e., a device making a connection request to connect to the vehicle) transmits the connection request to an authorization server. The authorization server verifies the connection request and generates an authorization certificate. The vehicle authenticates the authorization certificate and, upon such authentication, activates a vehicle communication system. Once the vehicle communication system is activated, the remote device (or another device) can communicate with the vehicle's internal systems. Because the authentication occurs before connection is made to the vehicle, such implementations can reduce the risk of unapproved access to the vehicle's internal systems. The discussion of FIG. 1 provides an overview of such a system.

FIG. 1 is a block diagram of a system 100 including example operations for allowing a connection to a vehicle 108, according to some implementations. The system includes a remote device 102, an authorization server 104, a diagnostic device 106, and the vehicle 108. A user (e.g., an automotive technician) may interact with the authorization server 104 and/or the vehicle 108 via a communications network (not shown). FIG. 1 depicts operations at stages A-K. The stages are examples and are not necessarily discrete occurrences over time (e.g., the operations of different stages may overlap). Additionally, FIG. 1 is an overview of example operations.

At stage A, the remote device 102 transmits a connection request 110 to the authorization server 104. For example, the user can, via a user input device of the remote device 102, generate the connection request 110. The connection request 110 requests connection to the vehicle 108, for example, for diagnostic and/or service work for the vehicle 108. The connection request 110 can include any suitable information (i.e., information associated with the connection request 110), as discussed herein. For example, the information associated with the connection request 110 can include a vehicle identifier (e.g., a vehicle identification number (VIN)), a make of the vehicle 108, a model of the vehicle 108, a trim of the vehicle 108, diagnostic information for the vehicle 108, a type of connection requested (e.g., wired, wireless, etc.), a type of service to be performed, an indication of vehicle systems to be accessed by the remote device 102, a duration of access requested, a time of access requested, an identity of an individual from which the connection request 110 was received, a type of facility from which the connection request 110 was received, information associated with the remote device 102, information associated with devices to be communicatively coupled to the vehicle 108, etc. In one implementation, the connection request 110 includes at least information identifying the vehicle 108 and the requestor (e.g., the user and/or device making the request).

At stages B-C, the authorization server 104 receives and verifies the connection request 110. The authorization server 104 can verify the connection request 110 in any suitable manner. For example, in one implementation, the authorization server 104 employs an account-based system. In such a system, automotive facilities (e.g., dealers, independent repair shops, etc.), and possibly individual technicians, can have accounts with account information (e.g., credentials) stored at the authorization server 104 and/or in a database associated with the authorization server 104. The connection request 110 can include, in addition to the information identifying the vehicle 108 and the requestor, credentials for the requestor. The authorization server 104 verifies the credentials and/or account information for the requestor. Further, in some embodiments, the authorization server 104 verifies whether the requested operations are registered and/or allowed based on the credentials and/or account information, and can verify device information. If the authorization server 104 verifies the connection request, at stage D, the authorization server 104 generates an authorization certificate 112 and, at stage E, the authorization server 104 transmits the authorization certificate 112 to the remote device 102 and/or the diagnostic device 106. In some embodiments, the authorization certificate 112 includes access operation details.

The authorization server 104 can secure the authorization certificate 112 in any suitable manner. For example, the authorization server 104 can secure the authorization certificate 112 via encryption. As one specific example, the authorization server 104 can employ a private key and public key pair to digitally sign the authorization certificate 112. That is, the authorization server 104 can digitally sign, and encrypt, the authorization certificate 112 via the private key. Once encrypted, only those with the public key can access the information contained in the authorization certificate 112. Further, because the authorization certificate 112 was encrypted with the private key, a second system (e.g., a system associated with the vehicle 108) can trust the authorization certificate 112 if it can be successfully decrypted with the public key.

At stages F and G, the remote device 102 receives and transmits the authorization certificate 112. It should be noted that, in some implementations, the authorization certificate 112 may be received from the authorization server 104 at devices in addition to, or other than, the remote device 102. As one example, if the diagnostic device 106 will ultimately connect to (i.e., be communicatively coupled to) the vehicle 108, the authorization server 104 can transmit the authorization certificate 112 to the diagnostic device 106 (whether directly or via the remote device 102). Additionally, or alternatively, the authorization server 104 can transmit the authorization certificate 112 directly to the vehicle 108. Regardless of where the authorization server 104 transmits the authorization certificate 112, this transmission will be generally referred to herein as directed to the remote device 102. The remote device 102 (or another device that has received the authorization certificate 112) then passes the authorization certificate 112 to the vehicle 108.

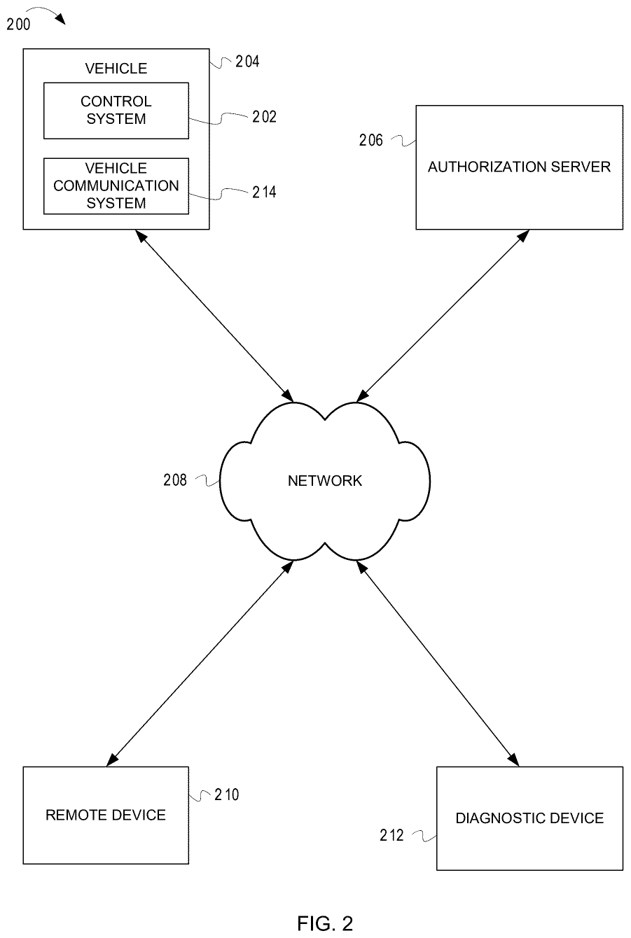

At stages H and I, the vehicle 108 receives and authenticates the authorization certificate 112. As previously noted, in one implementation, the authorization server 104 digitally signs and encrypts the authorization certificate 112 with a private key. In such embodiments, the vehicle 108 authenticates the authorization certificate 112 via the public key. Once the vehicle 108 authenticates the authorization certificate 112, the vehicle 108 activates a vehicle communication system at stage J. Additionally, in some embodiments, prior to activating the vehicle communication system, the vehicle 108 can first preconfigure one or more of the vehicle's 108 internal system (e.g., ECUs, gateways, etc.) for verifying and filtering operations, as described in more detail with respect to FIG. 2.

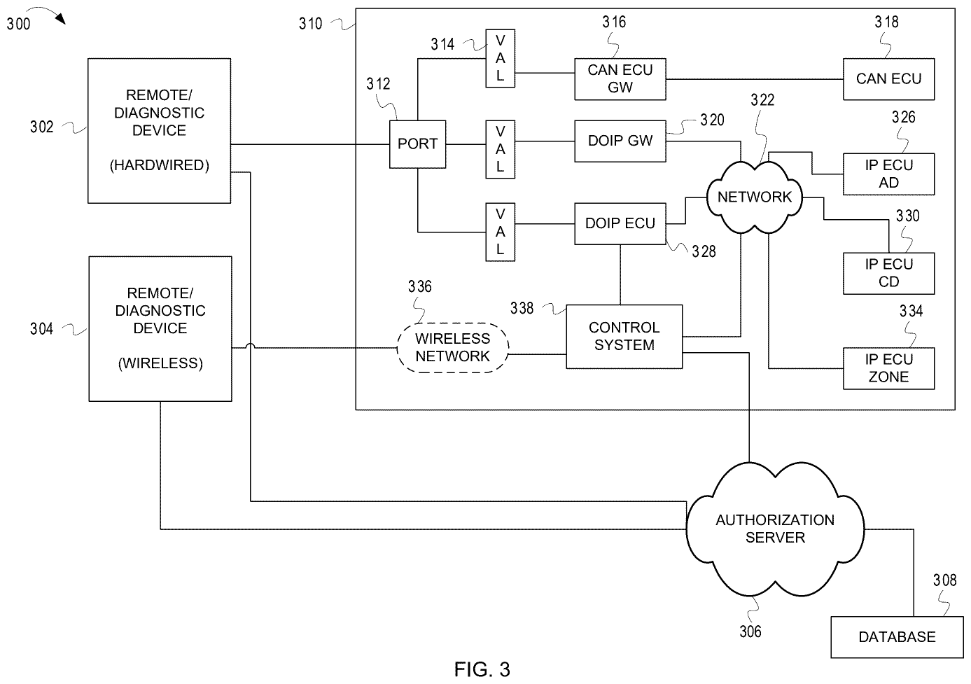

How the vehicle 108 activates the communication system may be dependent upon the type of the vehicle communication system. For example, if the vehicle communication system is based on a wired connection, the vehicle 108 activates the vehicle communication system by activating a wired port (e.g., an OBD port) of the vehicle 108. As one example, the vehicle 108 can include a vehicle access locker (VAL) that is communicatively located between a device to be connected to the vehicle 108 (e.g., the remote device 102 and/or the diagnostic device 106) and the wired port and/or between the wired port and the internal vehicle systems (as shown in the example depicted in FIG. 3). The VAL acts to prevent communications from passing to the wired port, or communications from the wired port to the internal vehicle systems, in a default state. When the vehicle 108 activates the vehicle communication system, the vehicle 108 “opens” the VAL and allows communications to pass between the device to be connected to the vehicle 108 and the vehicle's 108 internal systems. As another example, if the vehicle communication system is based on a wireless connection, the vehicle 108 can activate the vehicle communication system by enabling a wireless network. The wireless network can take any suitable form and operate over any suitable protocol (e.g., near field communication, the 802.11 standard, Zigbee, etc.). In one implementation, the vehicle 108 enables the wireless network by generating a network for the vehicle 108. For example, the vehicle 108 can generate the network for the vehicle by generating a service set identifier (SSID) and password for the network. In such implementations, the network credentials (e.g., the SSID and/or password) can be shared with the device to be connected to the vehicle 108. It should also be noted, that in some embodiments, the vehicle communications system may include both wired and wireless channels that are activated. Regardless of whether the vehicle communication system is based on wired, wireless, or both wired and wireless connections, because the vehicle communication system is not activated until the vehicle 108 authenticates the authorization certificate 112, communications between external devices (e.g., the remote device 102, the diagnostic device 106, etc.) and the vehicle 108 are prevented, or at least limited, before authentication. That is, the vehicle 108 has a zero trust relationship with external devices (e.g., the remote device 102 and/or the diagnostic device 106) until the vehicle 108 has authenticated the authorization certificate 112.

It should be noted that, in some embodiments, the authorization process does not end once the remote device 102 (or another device) connects (i.e., communicatively couples) to the vehicle 108. In such embodiments, the vehicle 108 and/or the authorization server 104 can monitor the communications between the vehicle 108 and a connected device. For example, once the vehicle communication system is activated, the vehicle 108 can verify that the device connecting to the vehicle 108 is the device that was expected to be connected to the vehicle 108. This can be performed in a variety of manners. As one example, the vehicle 108 can verify that an identifier of the device (e.g., a MAC address, IP address, etc.) matches the information that was in the authorization certificate 112. As another example, if the authorization certificate 112 includes temporal information associated with the connection, the vehicle 108 can verify that the timing of the connection is consistent with the temporal information in the authorization certificate 112. Further, in some embodiments, such monitoring can continue during the course of the connection. For example, the communications can be monitored and recorded. If a connection or action outside of the scope of the authorization certificate 112 is detected, the communications can be filtered and/or blocked and, in some instances, the vehicle communication system can be deactivated. In such embodiments, the vehicle 108 can transmit the recordings of communications to the authorization server 104.

While the discussion of FIG. 1 provides and overview of a system and example operations for allowing a connection to a vehicle, the discussion of FIGS. 2 and 3 provides additional detail regarding such a system.

FIG. 2 is a block diagram of a system 200 for allowing a connection to a vehicle 204, according to some implementations. The system 200 generally includes the vehicle 204, an authorization server 206, a network 208, a remote device 210, and a diagnostic device 212. It should be noted that in some implementations, the remote device 210 and the diagnostic device 212 may be a single device. The vehicle 204, authorization server 206, remote device 210, and diagnostic device 212 are communicatively coupled via the network 208. Accordingly, the network 208 can take any suitable form (e.g., a local area network (LAN), wide area network (WAN) such as the Internet, wireless wide area network (WWAN), etc.) and include wired and/or wireless links.

The remote device 210 is generally configured to generate connection requests. The connection request requests connection between the vehicle 204 and the remote device 210 and/or the diagnostic device 212. The connection can be for diagnostic purposes, repair purposes, data gathering purposes, data transfer purposes, software update purposes, etc. The connection request can include any suitable information, such as a vehicle identifier (e.g., a vehicle identification number (VIN), a make of the vehicle 204, a model of the vehicle 204, a trim of the vehicle 204, diagnostic information for the vehicle 204, a type of connection requested (e.g., wired, wireless, etc.), a type of service to be performed, an indication of vehicle systems to be accessed by the remote device 210, a duration of access requested, a time of access requested, an identity of an individual from which the connection request was received, a type of facility from which the connection request was received, information associated with the remote device 210, information associated with devices to be communicatively coupled to the vehicle 204, etc. The remote device 210 transmits the connection request to the authorization server 206 via the network 208.

The authorization server 206 is generally configured to verify connection requests and generate authorization certificates. That is, the authorization server 206 verifies that a communication request is a legitimate connection request and, in response, generates an authorization certificate. The authorization server 206 can verify the connection request in any suitable manner. For example, the authorization server 206 can verify the connection request via a PKI system, encryption, an account-based system, etc. With respect to encryption, in one implementation, the remote device 210 can digitally sign the connection request. Assuming the remote device 210 is a trusted device, decryption by the authorization server 206 can verify the identity of the remote device 210. With respect to an account-based system, the connection request can include credentials associated with a user of the remote device 210 and/or a facility associated with the user and/or the remote device 210. The credentials can include, for example, a username and password. In such implementations, the authorization server 206 can verify the connection request by verifying the credentials included in the connection request. Further, such systems can include two factor authentication between the remote device 210 and the authorization server 206. Additionally, in some implementations, the connection request can include operational details with respect to user accounts. For example, the connection request can include indications of operational roles, such as connecting wirelessly, infotainment system maintenance, battery maintenance, engine maintenance, etc. In such implementations, the authorization server 206 can verify not only the credentials, but also that the specified users are properly authorized based on the operational details. If the authorization server 206 is not able to verify the connection request (e.g., the credentials are incorrect, the connection request was not encrypted correctly, etc.), the authorization server 206 can actively or passively deny the connection request.

Once the authorization server 206 has verified the connection request, the authorization server 206 contains operation authorization information for each request and registered user account, it will verify if the requested operation can be authorized properly for the account. Once verified, the authorization server 206 generates an authorization certificate. In some embodiments, when verifying the connection request, the authorization server 206 authorizes information for the connection request and any user credentials (if applicable). Because the authorization certificate contains authorized request operations, the authorization certificate confirms for the vehicle 204 that the connection request was verified and the operations in the certificate are authorized. In one implementation, the authorization server 206 digitally signs and encrypts the authorization certificate. For example, the authorization server 206 can digitally sign and encrypt the authorization certificate with a private key.

The vehicle 204 can be of any suitable type (e.g., a commercial or passenger automobile, a boat, an aircraft, etc.) and includes numerous systems (e.g., electrical systems, a drivetrain, infotainment systems, climate control systems, safety systems, communications systems, sensor systems, self-driving systems, engine control systems, etc.). However, in an effort to not obfuscate the figures, the vehicle 204 is only shown as including a control system 202 and vehicle communication system 214.

The control system 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control system 202 is configured (for example, by using corresponding programming as will be well understood by those skilled in the art) to carry out one or more of the steps, actions, and/or functions described herein.

By one optional approach the control system 202 operably couples to a memory. The memory may be integral to the control system 202 or can be physically discrete (in whole or in part) from the control system 202 as desired. This memory can also be local with respect to the control system 202 (where, for example, both share a common circuit board, chassis, power supply, and/or housing) or can be partially or wholly remote with respect to the control system 202 (where, for example, the memory is physically located in another facility, metropolitan area, or even country as compared to the control system 202).

This memory can serve, for example, to non-transitorily store the computer instructions that, when executed by the control system 202, cause the control system 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control system 202 is generally configured to authenticate authorization certificates and activate vehicle communication systems, as well as perform other tasks associated with the vehicle 204. With respect to the authentication of authorization certificates, the control system 202 can employ whatever mechanism is suitable based on the type of authorization certificate. Continuing the example provided above in which the authorization server 206 digitally signed and encrypted the authorization certificate, the control system 202 can authenticate the authorization certificate via a public key of the public/private key pair. If the control system 202 can properly decrypt the authorization certificate with the public key, it indicates that the authorization certificate was signed and encrypted with the correct private key and thus originated from the authorization server 206 and has not been tampered with or otherwise altered. Further, because the authorization certificate originated from the authorization server 206 and the authorization server verified the connection request, the control system 202 can assume that the connection request is legitimate.

Further, in some embodiments, after the control system 202 authenticates the authorization certificate, but before the control system 202 activates the vehicle communication system 214, the control system 202 can configure the internal vehicle systems for ensuing communications. For example, the control system 202 can communicate information associated with the connection request to the vehicle's 204 ECU(s), gateway(s), etc. This information can include, for example, an indication of systems to be accessed and an indication of the device that will be accessing the systems. The vehicle's 204 ECU(s), gateway(s), etc. can then monitor the communications and allow only authorized operations to pass (e.g., while denying unauthorized communications). This operation monitoring could be implemented as operation rules or a filtering program such as eBPF, etc. Accordingly, operations can be identified with the signature such as MAC address and/or IP address and other message or protocol identifier related to authorization operations. Upon configuration and during the operation access, the control system 202 verifies each operation request passing by. During this monitoring, if the control system 202 detects incidents, unauthorized operations, and/or unauthorized access, the control system 202 can revoke the authorization, deactivate the communication and access, and report incidents to authorization server 206.

The control system's 202 function can distribute among one or more internal vehicle ECUs and gateways when applicable. The control system's 202 function can be implemented either in firmware such as FPGA, or in software stack such as CAN and or TCP/IP stack, where operation and signatures details can be inspected. The control system 202 is highly dynamically configurable, and the operation rule for monitoring can be updated in the runtime to adjust in modern vehicle environments.

Once the control system 202 authenticates the authorization certificate, the control system 202 activates the vehicle communication system 214. The vehicle communication system 214 can be based on a wired and/or wireless connection. For example, in the case of a wired system, the vehicle can include a physical port (e.g., an OBD port). The control system 202 can activate the physical port physically and/or electrically. As one example of a physical activation, the physical port may be blocked in some way such that a device cannot be connected to the physical port. For example, the physical port can be blocked by a door or other structure that prevents connection to the physical port. When the control system 202 activates the physical port in such implementations, the control system 202 can cause the door or other structure to be moved such that access to the physical port is no longer prevented. Additionally, or alternatively, the control system 202 can activate the physical port electronically. In such implementations, the vehicle 204 can include a VAL. The VAL can be communicatively located before the physical port or between the physical port and the vehicle's internal systems. In a default state, the VAL can block or otherwise prevent communications through the physical port and/or from the physical port to the vehicle's internal systems. Once the control system 202 activates the physical port, the VAL allows communications to pass to, and/or from, the physical port to the vehicle's internal systems. With respect to a wireless system, the control system 202 can activate the vehicle communication system by enabling a wireless network associated with the vehicle 204 and/or broadcast by the vehicle 204. For example, the control system 202 can enable the wireless network by generating the wireless network, allowing outside connection to the wireless network, making the wireless network visible to external devices, etc. As one example, the control system 202 can enable the wireless network by generating an SSID and password for the wireless network.

In some embodiments, the control system 202 can further control and/or limit access to the vehicle's 204 internal systems based on the connection request. For example, assuming the connection request includes information from which specific vehicle systems can be identified, the control system 202 can identify one or more vehicle systems to which access is required. For example, the connection request can explicitly or implicitly include this information, or the control system 202 can infer this information based on information about the connection that is requested and/or the service to be performed. In such implementations, the control system 202 can activate the vehicle communication system such that only those vehicle systems that are required to be accessed are accessible. For example, if the connection request is to perform a software update on the vehicle's 204 infotainment system, the control system 202 can enable only communications to the vehicle systems associated with the infotainment system while blocking other communications (e.g., communications to a LiDAR system associated with the vehicle's 204 self-driving features).

As previously noted, the system 200 includes a diagnostic device 212 and that, in some implementations, the diagnostic device 212 and the remote device 210 can be the same device. The diagnostic device 212 is generally a device that connects to the vehicle communication system 214. The diagnostic device 212 can receive data from, and possibly transmit data to, the vehicle's internal systems via the vehicle communication system 214. Accordingly, the diagnostic device 212 can receive diagnostic information from the vehicle 204 and/or transmit data to the vehicle 204 to provide software updates, alter operational parameters, clear codes, etc.

FIG. 3 is a block diagram of a sample implementation of a system 300 for allowing connection to a vehicle including additional detail with respect to FIG. 2, according to some implementations. The system 300 generally comprises a remote/diagnostic device (hardwired) 302, a remote/diagnostic device (wireless) 304, a vehicle 310, an authorization server 306, and a database 308. Though the remote/diagnostic device (hardwired) 302 and the remote/diagnostic device (wireless) 304 are depicted as separate components in the example depicted in FIG. 3, it should be noted that the remote/diagnostic device (hardwired) 302 and the remote/diagnostic device (wireless) 304 can be the same component. Additionally, though the remote/diagnostic device (hardwired) 302 and the remote/diagnostic device (wireless) 304 are labelled as “remote/diagnostic” devices, it should be noted that these blocks can represent any number of devices with a variety of purposes. That is, the remote/diagnostic device (hardwired) 302 and the remote/diagnostic device (wireless) 304 simply represent devices that seek to communicatively couple (i.e., “connect”) to the vehicle 310 for any purpose for which establishing a communication with the vehicle 310 is required or preferred. For the ease of discussion, both the remote/diagnostic device (hardwired) 302 and the remote/diagnostic device (wireless) 304 will generally be referred to as a “remote device,” unless functionality specific to one of the remote/diagnostic device (hardwired) 302 and the remote/diagnostic device (wireless) 304 is being discussed.

The vehicle 310 includes a variety of components, and those shown in FIG. 3 are but examples of components included in the vehicle 310. That is, the vehicle 310 may include greater, fewer, and/or different components than those depicted in FIG. 3. As depicted in FIG. 3, the vehicle 310 includes a port 312 (e.g., an onboard diagnostic port), one or more vehicle access lockers (“VALs”) 314, a plurality of gateways (e.g., a CAN ECU gateway 316 and a DOIP gateway 320), a control system 338, an internal network 322, and a plurality of electronic control units (ECUs), such as a CAN ECU 318, an IP ECU AD 326, an IP ECU CD 330, and an IP ECU zone 334.

As previously discussed, the remote device generates a connection request and transmits the connection request to the authorization server 306. The authorization server 306 verifies the connection request. For example, the connection request can include credentials associated with the remote device and/or a user that is requesting connection to the vehicle 310. In such implementations, the authorization server 306 can verify the credentials in the database 308. Once the authorization server 306 verifies the connection request, the authorization server 306 generates an authorization certificate. The authorization server 306 digitally signs and encrypts the authorization certificate and transmits the authorization certificate to the vehicle 310 and/or the remote device. The authorization certificate is received by the vehicle 310 via the control system 338. The control system 338 generally authenticates the authorization certificate and thus can be referred to as a “vehicle authorization server” and/or including the functionality of a “vehicle authorization server.”

Further, as noted previously, in some embodiments, after the authorization certificate is received by the vehicle 310, the vehicle 310 can preconfigure its internal systems for the communication. For example, the authorization certificate can include operational details, such as an indication of the device(s) to be connected to the vehicle 310, the internal systems that will be accessed, etc. The vehicle 310 can configure the internal systems by, for example, initiating a monitoring protocol by the internal vehicle systems. The internal vehicle systems can then monitor the communications and/or connections during runtime to ensure that the communications and/or connections are consistent with the operational authorizations.

As previously discussed, in some implementations, before an authorization certificate is authenticated by the vehicle (e.g., the control system 338), there is no trust between the vehicle and the remote device. That is, the vehicle 310 will not accept (e.g., will block) communications from the remote device unless and until the authorization certificate is authenticated. Once the vehicle 310 authenticates the authorization certificate (e.g., by decrypting the authorization certificate), the vehicle 310 can activate a vehicle communication system. Generally speaking, the vehicle communication system can be, or can be associated with, a wired and/or wireless communication system, such as the port 312 and the wireless network 336, respectively.

With respect to the wired communication system, the vehicle 310 can include one or more VALs 314. The VALs 314 can be hardware and/or software components that are positioned between the remote device and the internal vehicle systems (e.g., the gateways, ECUs, internal networks, etc.). The VALs 314 generally have an input and an output in both directions. From the outside to internal vehicle direction, the input is configured to receive communications from the remote device, and the output is configured to transmit the communications from the remote device to the internal systems of the vehicle 310. When disabled, the VALs 314 block communications from passing through the VALs 314. As one example, in the disabled state, the input and output of the VALs 314 can be decoupled (e.g., via a switch) of both directions such that no communication channel exists between the input and the output of the VAL 314. When enabled, the VALs 314 allow communications to pass between the input and the output.

In implementations that include a single VAL 314, the VAL 314 can control the transmission of communications from the remote device to some, or all, of the internal vehicle systems. That is, the single VAL 314 can either allow communications to pass from its input to its output which is connected to a variety of the internal vehicle systems, or disabled such that no such communication channel exists.

In implementations that include multiple VALs 314 (such as the system 300 depicted in FIG. 3), each VAL 314 can be specific to one or more of the internal vehicle systems. For example, as depicted in FIG. 3, a first of the VALs 314 is associated with the CAN ECU gateway 316, a second of the VALs 314 is associated with the DOIP gateway 320, and a third of the VALs 314 is associated with the DOIP ECU 328. Accordingly, the VALs 314 control the communications between the port 312 and each of the internal vehicle systems. In some implementations, the connection request can include information, whether explicit or implicit, that allow the control system 338 to determine to which of the internal vehicle systems the remote device needs access. In such implementations, the control system 338 can enable only the required VALs 314, thus preventing the remote device from gaining access to internal vehicle systems to which access is not required. Additionally, or alternatively, the authorization server 306 can use the information in the connection request to identify the internal vehicle systems to which the remote device needs access. In such implementations, the authorization server 306 can include an indication of the internal vehicle systems to which access is required. Similarly, the connection request can specify, explicitly or implicitly, whether a wired or wireless connection is requested. In such implementations, the control system 338 can activate the appropriate vehicle communication system.

Additionally, in some implementations, as described, the control system 338 can monitor the connection between the remote device and the vehicle communication system and/or the internal vehicle systems while remote device is communicating with the vehicle communication system (i.e., during “runtime”). If the communications between the remote device and the vehicle communication system are outside of the scope of explicit, implicit, or implied communications based on the information in the connection request (including, for example, the operational details), the vehicle 310 can revoke permissions of the remote device. For example, the vehicle 310 can revoke permissions by deactivating the vehicle communication system. Such revocation can be based on any suitable criteria, such as the timing of the connection, the duration of the connection, the internal vehicle systems being accessed, the internal vehicle systems to which access is attempted, an identifier of the remote device (e.g., a MAC address, IP address, etc.) being different than listed in the connection request, etc.

The control system 338 can further monitor the operation details between the remote device and the internal vehicle systems according to the operation authorization in the authorization certificate, such as destination ECU identifier, IP address, operation and or message type and identifier, etc. The control system 338 can reject any unauthorized operation request, revoke authorization upon certain circumstance, etc. In some embodiments, once configured and activated, the control system 338 monitors operation during the entire access period, and deactivates the access when the authorization expires or should be revoked. Further, in some embodiments, the authorization certificate can be updated and therefore the control system 338 can adapt the monitoring at runtime upon request from the authorization server 306.

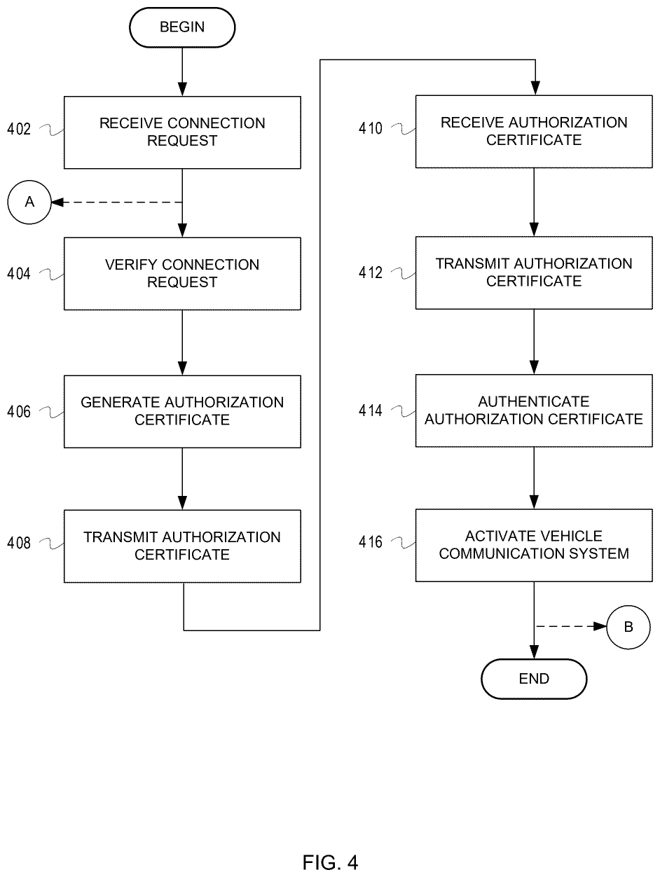

While the discussion of FIGS. 2 and 3 provides additional detail regarding a system for allowing a connection to a vehicle, the discussion of FIGS. 4-6 provides additional detail regarding example operations of such a system.

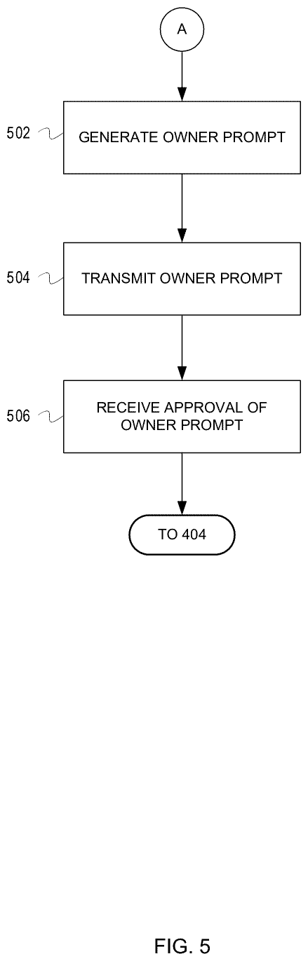

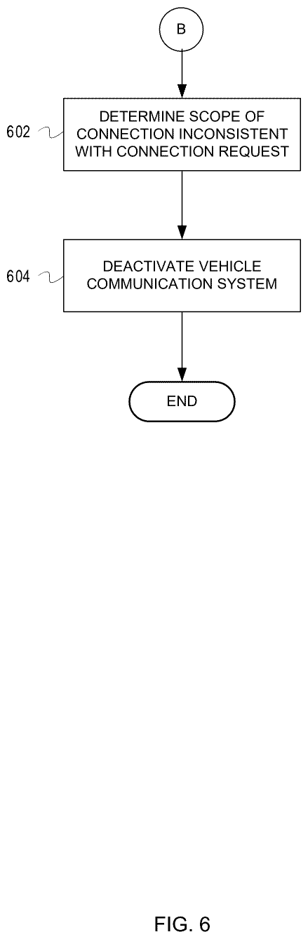

FIGS. 4-6 are flow charts depicting example operations for allowing a connection to a vehicle, according to some implementations. It should be noted that the flow chart depicted in FIG. 4 includes additional example operations, denoted by A and B, which proceed in FIGS. 5 and 6, respectively. The flow begins at block 402.

At block 402, a connection request is received. For example, the connection request can be received at an authorization server from a remote device. The connection request generally requests a connection to a vehicle and can include any suitable information. At a high level, the connection request includes information identifying the requestor (e.g., a user requesting the connection, the device requesting the connection, etc.) and the vehicle. Optionally, in implementations in which an owner prompt is generated, the flow continues at block 502 of FIG. 5, as indicated by A. In implementations in which an owner prompt is not generated, the flow continues at block 404.

At block 502, an owner prompt is generated. For example, the authorization server can generate the owner prompt. In some implementations, the authorization server generates the owner prompt in response to receipt of the connection request. Generally, the owner prompt is an alert that is generated for a user of the vehicle (e.g., an owner, lessee, renter, operator, etc. of the vehicle). The owner prompt can include any suitable information. For example, the owner prompt can include a vehicle identifier, a make of the vehicle, diagnostic information for the vehicle, a type of connection requested, a type of service to be performed, an indication of vehicle systems to be accessed by the remote device, a duration of access requested, a time of access requested, an identity of an individual from which the connection request was received, a type of facility from which the connection request was received, information associated with the remote device, information associated with devices to be communicatively coupled to the vehicle, etc. The flow continues at block 504.

At block 504, the owner prompt is transmitted. For example, the authorization server can transmit the owner prompt to a user device associated with the user of the vehicle. The authorization server transmits the owner prompt via a network via any suitable protocol. For example, the owner prompt may be transmitted as a simple message service (SMS) message, multimedia message service (MMS) message, email, phone call, etc. The user of the vehicle can view the owner prompt via the user device (e.g., a cellular phone, a smartphone, a laptop computer, a desktop computer, a tablet computer, a smartwatch, a wearable device, etc.). The user of the vehicle can then approve or deny, or possibly request more information regarding, the owner prompt. The flow continues at block 506.

At block 506, assuming the user of the vehicle approved the owner prompt or in implementations where approval is not required, approval of the owner prompt (or a lack of communication) is received by the authorization server from the user device associated with the user of the vehicle. The flow continues at block 404 of FIG. 4.

At block 404, the connection request is verified. For example, the authorization server can verify the connection request. The authorization server can verify the connection request in any suitable manner. For example, the authorization server can verify the connection request via encryption, an account-based system, etc. With respect to encryption, in one implementation, the remote device can digitally sign the connection request. Assuming the remote device is a trusted device, decryption by the authorization server can verify the identity of the remote device. With respect to an account-based system, the connection request can include credentials associated with a user of the remote device and/or a facility associated with the user and/or the remote device. The credentials can include, for example, a username and password. In such implementations, the authorization server can verify the connection request by verifying the credentials included in the connection request. Further, such systems can include two factor authentication between the remote device and the authorization server. If the authorization server is not able to verify the connection request (e.g., the credentials are incorrect, the connection request was not encrypted correctly, etc.), the authorization server can actively or passively deny the connection request. Additionally, in some embodiments, the authorization server can verify that the operations requested by the requestor are allowable. This verification may be specific to the requestor (e.g., different requestors may have authorization access to different internal vehicle systems because of their different user roles). The flow continues at block 406.

At block 406, an authorization certificate is generated. For example, the authorization server can generate the authorization certificate. The authorization certificate confirms for the vehicle that the connection request was verified and thus authorized. In one implementation, the authorization server digitally signs and encrypts the authorization certificate. For example, the authorization server can digitally sign and encrypt the authorization certificate with a private key. The authorization certificate can include any suitable information, such as some, or all, of the information included in the connection request as well as information added by the authorization server (e.g., the internal vehicle systems to which access is authorized). The flow continues at block 408.

At block 408, the authorization certificate is transmitted. For example, the authorization server can transmit the authorization certificate. The flow continues at block 410.

At block 410, the authorization certificate is received. The authorization certificate can be received by any suitable device. For example, the remote device or a diagnostic device can receive the authorization certificate from the authorization server. The flow continues at block 412.

At block 412, the authorization certificate is transmitted. For example, the remote device and/or diagnostic device can transmit the authorization certificate. The authorization certificate is transmitted to the vehicle. The flow continues at block 414.

At block 414, the authorization certificate is authenticated. For example, the vehicle can authenticate the authorization certificate. The vehicle can employ any suitable mechanism to authenticate the authorization certificate based on the type of authorization certificate. Continuing the example provided above in which the authorization server digitally signed and encrypted the authorization certificate, the vehicle can authenticate the authorization certificate via a public key of the public/private key pair. If the vehicle can properly decrypt the authorization certificate with the public key, it indicates that the authorization certificate was signed and encrypted with the correct private key and thus originated from the authorization server and has not been tampered with or otherwise altered. Further, because the authorization certificate originated from the authorization server and the authorization server verified the connection request, the vehicle can assume that the connection request is legitimate. The flow continues at block 416.

At block 416, a vehicle communication system is activated. For example, the vehicle can activate the vehicle communication system. The vehicle activates the vehicle communication system in response to the authentication of the authorization certificate. The vehicle communication system can be a wired and/or wireless communication system. In the case of a wired communication system, the vehicle can activate the vehicle communication system by enabling a physical port of the vehicle. In the case of a wireless communication system, the vehicle can activate the vehicle communication system by enabling a wireless network associated with, or broadcast by, the vehicle. Additionally, as noted previously, in some embodiments, the vehicle configures the internal vehicle systems to receive the communications before the vehicle communication system is activated. Optionally, in implementations in which the vehicle communication system can be deactivated (e.g., during runtime monitoring), the flow continues at block 602, as indicated by B.

At block 602, it is determined that a scope of connection is inconsistent with the connection request. For example, the vehicle can determine that the scope of the connection is inconsistent with the connection request. As previously discussed, the connection request can include information associated with what internal vehicle systems are to be accessed, a duration of the access, types of communications necessary, etc. Similarly, this information can be passed to the vehicle (e.g., in the authorization certificate). In such implementations, the vehicle can monitor the connection between the vehicle and the remote device and/or diagnostic device. The scope of the connection is inconsistent with the connection request when an external device (e.g., the remote device, diagnostic device, etc.) attempts to connect to internal vehicle systems other than those specified, transmit data other than those specified, connect during a time outside of that specified, etc. in the connection request. As noted previously, this monitoring can be done during runtime. The flow continues at block 604.

At block 604, the vehicle communication system is deactivated. For example, the vehicle can deactivate the vehicle communication system. The vehicle deactivates the vehicle communication system in response to the determination that the scope of the connection is inconsistent with the connection request.

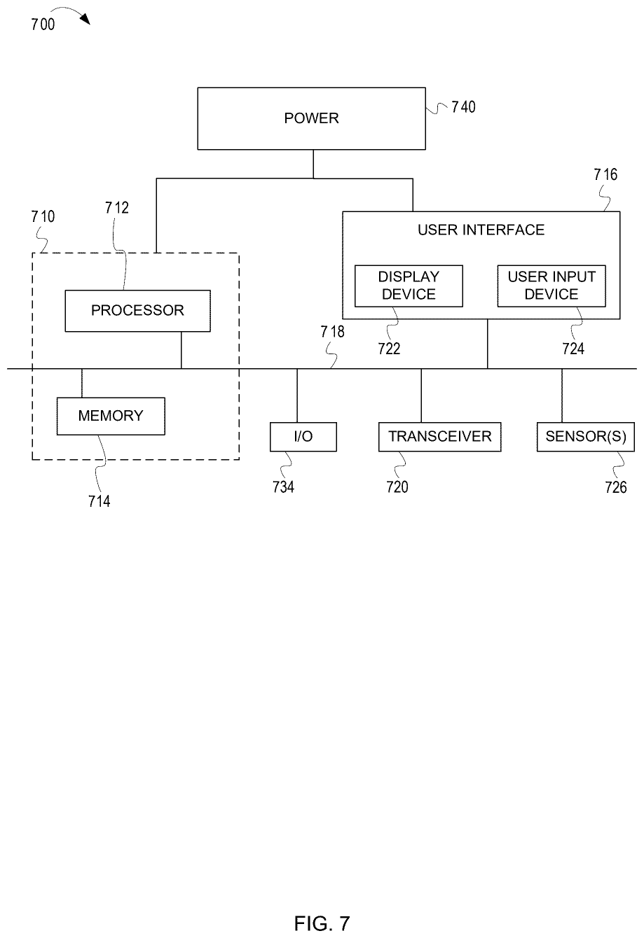

While the discussion of FIGS. 4-6 provides additional detail regarding example operations of a system for allowing a connection to a vehicle, the discussion of FIG. 7 provides additional detail regarding specific components of such a system.

FIG. 7 is a block diagram of a system that may be used for implementing any of components, circuits, circuitry, systems, functionality, apparatuses, processes, or devices of the system of FIG. 2 and/or 3, and/or other above or below mentioned systems or devices, or parts of such circuits, circuitry, functionality, systems, apparatuses, processes, or devices, according to some embodiments. The circuits, circuitry, systems, devices, processes, methods, techniques, functionality, services, servers, sources and the like described herein may be utilized, implemented and/or run on many different types of devices and/or systems. For example, the system 700 may be used to implement some or all of the control system, the authorization server, the remote device, the user device, the diagnostic device, and/or other such components, circuitry, functionality and/or devices. However, the use of the system 700 or any portion thereof is certainly not required.

By way of example, the system 700 may comprise a processor (e.g., a control system) 712, memory 714, and one or more communication links, paths, buses or the like 718. Some embodiments may include one or more user interfaces 716, and/or one or more internal and/or external power sources or supplies 740. The processor 712 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the processor 712 can be part of control system and/or a control system 710, which may be implemented through one or more processors with access to one or more memory 714 that can store commands, instructions, code and the like that is implemented by the control system and/or processors to implement intended functionality. In some applications, the control system and/or memory may be distributed over a communications network (e.g., LAN, WAN, the Internet) providing distributed and/or redundant processing and functionality. Again, the system 700 may be used to implement one or more of the above or below, or parts of, components, circuits, systems, processes and the like.

The user interface 716 can allow a user to interact with the system 700 and receive information through the system. In some instances, the user interface 716 includes a display device 722 and/or one or more user input device 724, such as buttons, touch screen, track ball, keyboard, mouse, etc., which can be part of or wired or wirelessly coupled with the system 700. In some implementations, the display device 722 can project a barcode onto the windshield of the vehicle, and when scanned by user's smart device, the barcode can redirect the user to input, via the user input device 724, the user's credentials and/or account information associated with the authorization server. In this way, the user can remotely interact with the authorization server as described above to generate and transmit connection request, receive and transmit authorization certificate, and obtain vehicle physical access (e.g., being able to open the door and enter the vehicle) and activated access to vehicle internal systems. Typically, the system 700 further includes one or more communication interfaces, ports, transceivers 720 and the like allowing the system 700 to communicate over a communication bus, a distributed computer and/or communication network (e.g., a local area network (LAN), wide area network (WAN) such as the Internet, etc.), communication link 718, other networks or communication channels with other devices and/or other such communications or combination of two or more of such communication methods. Further the transceiver 720 can be configured for wired, wireless, optical, fiber optical cable, satellite, or other such communication configurations or combinations of two or more of such communications. Some embodiments include an I/O interface including one or more input/output (I/O) ports 734 that allow one or more devices to couple with the system 700. The I/O ports 734 can be substantially any relevant port or combinations of ports, such as but not limited to USB, Ethernet, or other such ports. The I/O interface can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers 720, or combination of two or more of such devices.

In some embodiments, the system may include one or more sensors 726 to provide information to the system and/or sensor information that is communicated to another component, such as the central control system, a delivery vehicle, etc. The sensors 726 can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, imaging system and/or camera, other such sensors or a combination of two or more of such sensor systems. The foregoing examples are intended to be illustrative and are not intended to convey an exhaustive listing of all possible sensors. Instead, it will be understood that these teachings will accommodate sensing any of a wide variety of circumstances in a given application setting.

The system 700 includes an example of a control and/or processor-based system with the processor 712. Again, the processor 712 can be implemented through one or more processors, controllers, central processing units, logic, software and the like. Further, in some implementations the processor 712 may provide multiprocessor functionality.

The memory 714, which can be accessed by the processor 712, typically includes one or more processor-readable and/or computer-readable media accessed by at least the control system, and can include volatile and/or nonvolatile media, such as RAM, ROM, EEPROM, flash memory and/or other memory technology. Further, the memory 714 is shown as internal to the control system 710; however, the memory 714 can be internal, external or a combination of internal and external memory. Similarly, some, or all, of the memory 714 can be internal, external or a combination of internal and external memory of the processor 712. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory 714 may be distributed at multiple locations over a computer network. The memory 714 can store code, software, executables, scripts, data, content, lists, programming, programs, log or history data, user information, customer information, product information, and the like. While FIG. 7 illustrates the various components being coupled together via a bus, it is understood that the various components may actually be coupled to the control system and/or one or more other components directly.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

Various aspects of the embodiments described above may be used alone, in combination, or in a variety of arrangements not specifically discussed in the embodiments described in the foregoing and the description is therefore not limited in its application to the details and arrangement of components set forth in the foregoing description or illustrated in the drawings. For example, aspects described in one embodiment may be combined in any manner with aspects described in other embodiments.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method for allowing a connection to a vehicle, the method comprising:
receiving, by an authorization server from a remote device, a connection request for the vehicle;
verifying, by the authorization server, the connection request;
in response to verifying the connection request, generating by the authorization server, an authorization certificate;
transmitting, by the authorization server, the authorization certificate;
receiving, by the vehicle, the authorization certificate;
authenticating, by the vehicle, the authorization certificate; and
in response to the authenticating the authorization certificate, activating, by the vehicle, a vehicle communication system.

2. The method of claim 1, wherein the connection request includes information associated with the connection request, wherein the information associated with the connection request includes a vehicle identifier, a make of the vehicle, a model of the vehicle, a trim of the vehicle, diagnostic information for the vehicle, a type of connection requested, a type of service and operations to be performed, an indication of vehicle systems to be accessed by the remote device, a duration of access requested, a time of access requested, an identity of an individual from which the connection request was received, a type of facility from which the connection request was received, information associated with the remote device, information associated with devices to be communicatively coupled to the vehicle, or any combination thereof.

3. The method of claim 2, further comprising:
determining, based on the information associated with the connection request, that a scope of connection to the vehicle is inconsistent with the information associated with the connection request; and
in response to the determining that the scope of the connection to the vehicle is inconsistent with the information associated with the connection request, deactivating, by the vehicle, the vehicle communication system.

4. The method of claim 1, further comprising:
encrypting, by the authorization server, the authorization certificate, wherein the authenticating the authorization certificate includes decrypting the authorization certificate.

5. The method of claim 1, wherein the verifying the connection request includes verifying operational details included in the connection request, the method further comprising:
in response to the verifying the connection request, including, in the authorization certificate by the authorization server, operational authorizations, wherein the operational authorizations indicate allowed operational roles associated with the connection request.

6. The method of claim 5, further comprising:
determining that the connection to the vehicle is outside of a scope of the operational authorizations; and
deactivating the vehicle communication system.

7. The method of claim 1, wherein the vehicle communication system is an onboard diagnostic system, and wherein the activating the vehicle communication system comprises activating an onboard diagnostic port of the vehicle.

8. The method of claim 1, further comprising:
in response to receipt of the connection request for the vehicle, generating an owner prompt by the authorization server;
transmitting, by the authorization server to a user device associated with an owner of the vehicle, the owner prompt;
receiving, from the user device, approval of the owner prompt;
wherein the activating the vehicle communication system is further in response to the approval of the owner prompt.

9. The method of claim 8, wherein the owner prompt includes a vehicle identifier, a make of the vehicle, diagnostic information for the vehicle, a type of connection requested, a type of service and operations to be performed, an indication of vehicle systems to be accessed by the remote device, a duration of access requested, a time of access requested, an identity of an individual from which the connection request was received, a type of facility from which the connection request was received, information associated with the remote device, information associated with devices to be communicatively coupled to the vehicle, or any combination thereof.

10. The method of claim 1, further comprising:
identifying, by the vehicle based on the authorization certificate, a first vehicle system to which access is required; and
providing access, via the vehicle communication system, to the first vehicle system.

11. A system for allowing a connection to a vehicle, the system comprising:
an authorization server, wherein the authorization server is configured to:
receive, from a remote device, a connection request for the vehicle;
verify the connection request;
in response to verifying the connection request, generate an authorization certificate; and
transmit the authorization certificate; and
the vehicle, wherein the vehicle is configured to:
authenticate the authorization certificate; and
in response to authenticating the authorization certificate, activate a vehicle communication system.

12. The system of claim 11, wherein the connection request includes information associated with the connection request, wherein the information associated with the connection request includes a vehicle identifier, a make of the vehicle, a model of the vehicle, a trim of the vehicle, diagnostic information for the vehicle, a type of connection requested, a type of service and operations to be performed, an indication of vehicle systems to be accessed by the remote device, a duration of access requested, a time of access requested, an identity of an individual from which the connection request was received, a type of facility from which the connection request was received, information associated with the remote device, information associated with devices to be communicatively coupled to the vehicle, or any combination thereof.

13. The system of claim 12, wherein the duration of access requested is provided to the vehicle, and wherein the vehicle is further configured to:
determine, based on the information associated with the connection request, that a scope of connection to the vehicle is inconsistent with the information associated with the connection request; and
in response to the determining that the scope of the connection to the vehicle is inconsistent with the information associated with the connection request, deactivate the vehicle communication system.

14. The system of claim 11, wherein the authorization server is further configured to:
encrypt the authorization certificate, wherein the vehicle authenticates the authorization certificate by decrypting the authorization certificate.

15. The system of claim 11, wherein the authorization server verifies the connection request by verifying operational details included in the connection request, and wherein the authorization server is further configured to:
in response to verifying the connection request, include, in the authorization certificate, operational authorizations, wherein the operational authorizations indicate allowed operational roles associated with the connection request.

16. The system of claim 15, wherein the authorization server is further configured to:
determine that the connection to the vehicle is outside of a scope of the operational authorizations; and
deactivate the vehicle communication system.

17. The system of claim 11, wherein the vehicle communication system is an onboard diagnostic system, and wherein the activating the vehicle communication system comprises activating an onboard diagnostic port of the vehicle.

18. The system of claim 11, wherein the authorization server is further configured to:
in response to receipt of the connection request for the vehicle, generate an owner prompt;
transmit, to a user device associated with an owner of the vehicle, the owner prompt; and
receive, from the user device, approval of the owner prompt;
wherein the vehicle communication system is activated further in response to the approval of the owner prompt.

19. The system of claim 18, wherein the owner prompt includes a vehicle identifier, a make of the vehicle, diagnostic information for the vehicle, a type of connection requested, a type of service and operations to be performed, an indication of vehicle systems to be accessed by the remote device, a duration of access requested, a time of access requested, an identity of an individual from which the connection request was received, a type of facility from which the connection request was received, information associated with the remote device, information associated with devices to be communicatively coupled to the vehicle, or any combination thereof.

20. The system of claim 11, wherein the vehicle is further configured to:
identify, based on the authorization certificate, a first vehicle system to which access is required; and
provide access, via the vehicle communication system, to the first vehicle system.
